(19) United States
(12) Patent Application Publication
(10) Pub. No.: US 2022/0393929 A1
(43) Pub. Date: Dec. 8, 2022

(54) DIGITAL INTERFACE FOR FREQUENCY DOMAIN DATA TRANSFER BETWEEN BASEBAND AND RADIOFREQUENCY MODULES

(71) Applicant: ZEKU, INC., Palo Alto, CA (US)

(72) Inventors: JIFENG GENG, Palo Alto, CA (US); HONG KUI YANG, Palo Alto, CA (US)

(21) Appl. No.: 17/819,748

(22) Filed: Aug. 15, 2022

Related U.S. Application Data
(63) Continuation of application No. PCT/US2020/066933, filed on Dec. 23, 2020.
(60) Provisional application No. 62/982,627, filed on Feb. 27, 2020.

(51) Int. Cl. H04L 27/26; H04B 1/40

(52) U.S. Cl. CPC H04L 27/26526; H04B 1/40; H04L 27/2605

(57) ABSTRACT

An electronic circuit includes a baseband (BB) integrated circuit (IC) semiconductor device connected to a radiofrequency (RF) IC semiconductor device through a digital interface. The BB IC semiconductor device is configured to generate time domain uplink data including symbols. The RF IC semiconductor device has a fast Fourier transfer (FFT) module configured to convert time domain downlink data to frequency domain downlink data and an inverse fast Fourier transfer (IFFT) module configured to convert frequency domain uplink data to time domain uplink data. The digital interface is configured to transfer the frequency domain uplink data and the frequency domain downlink data between the BB module and the RF module.

### CROSS-REFERENCE TO RELATED APPLICATION(S)

This application is a continuation of PCT International Application No. PCT/US2020/066933, titled “Digital Interface for Frequency Domain Data Transfer Between Baseband and Radiofrequency Modules,” filed Dec. 23, 2020, which claims priority to U.S. Provisional Application No. 62/982,627, titled “Transfer Frequency Domain Data to Reduce BB-RF Digital Interface Throughput,” filed on Feb. 27, 2020. The aforementioned applications are incorporated herein by reference in their entirety.

### TECHNICAL FIELD

The disclosed teachings relate to digital interfaces between baseband and radiofrequency modules in radio communications.

### BACKGROUND

Modern wireless communication systems typically separate baseband (BB) and radiofrequency (RF) functions into distinct integrated circuit (IC) chips. The amount of information exchanged between the BB and RF chips has increased in recent years due to improvements in radio system transmission capabilities. With increased uplink/downlink throughput, the interface to exchange data between BB and RF chips is more efficient in a digital format.

A trend to standardize the digital interface has emerged. For example, SerDes is standardized technology for data transmission over a single line or a differential pair where data is converted between serial data and parallel interfaces in each direction in order to minimize the number of I/O pins and interconnects. DigRF specifications describe the logical, electrical, and timing characteristics of a digital interface to allow physical implementation of the interface for mobile devices. M-PHY is a high-speed data communications physical layer protocol standard that is targeted at the needs of mobile multimedia devices.

With the introduction of 4G/5G telecommunications, the throughput on the digital interface is pushed even higher. To accommodate the ever-increasing demand for throughput, the digital interface implements multiple lanes for data transfers. Nevertheless, the required high throughput has brought challenges to both physical design of the interface and power consumption by power sensitive devices such as mobile phones.

### BRIEF DESCRIPTION OF THE DRAWINGS

Embodiments of the present technology will be described and explained through the use of the accompanying drawings.

FIG. 1 is a block diagram that illustrates an architecture including a digital interface for baseband (BB) and radiofrequency (RF) modules.

FIG. 2A is a flowchart that illustrates a process for processing uplink data through a BB-RF digital interface.

FIG. 2B is a flowchart that illustrates a process for processing downlink data through the BB-RF digital interface.

FIG. 3 is a block diagram that illustrates an example of a processing system in which at least some operations described herein can be implemented.

Various features of the technologies described herein will become more apparent to those skilled in the art from a study of the Detailed Description in conjunction with the drawings. Embodiments are illustrated by way of example and not limitation in the drawings, in which like references may indicate similar elements. While the drawings depict various embodiments for the purpose of illustration, those skilled in the art will recognize that alternative embodiments may be employed without departing from the principles of the technologies. Accordingly, while specific embodiments are shown in the drawings, the technology is amenable to various modifications.

### DETAILED DESCRIPTION

The disclosed solution includes a digital interface between baseband (BB) and radiofrequency (RF) modules. The term “module” refers to a component part that can be embodied as hardware, software, or a combination of both. An example of a module in the context of a BB-RF interface includes an integrated circuit (IC) semiconductor device (e.g., chip) or component of the IC chip. The disclosed digital interface minimizes or reduces throughput needed to transfer digital data efficiently between BB and RF modules. The reduced throughput improves over existing digital interfaces by, among other things, reducing power consumption. The reduction in throughput results by transferring data through the digital interface in the frequency domain rather than in the time domain. The transfer of frequency domain data is enabled with a circuit architecture that has certain components in the RF module, which are typically found on the BB module.

The architecture reflects advances in process technology (also referred to as “process node”), which refers to specific semiconductor manufacturing processes and associated design rules. Generally, a smaller process technology corresponds to smaller feature size, producing smaller transistors which are both faster and more power-efficient. Recent process technology such as 22 nm, 16 nm, 14 nm, 10 nm, 6 nm, and 2 nm refer to specific generations of chips. In typical BB-RF circuit design, the RF module is more physically compact compared to the BB module. Given the reduction in process technology, relatively larger components such as a fast Fourier transfer (FFT) module (e.g., engine) and an inverse fast Fourier transfer (IFFT) engine can be placed on an RF IC chip rather than a BB IC chip while keeping the RF module physically compact.

In contrast, conventional systems pass time domain data through the digital interface. The time domain data carries excessive amounts of overhead because the total amount of bits transferred through the digital interface remains constant despite only a lesser amount carrying meaningful data (e.g., the total amount includes empty tones and a cyclic prefix). As such, there is proportionally more overhead as the meaningful amount of data decreases in the time domain. On the other hand, the total bits scale in the frequency domain because the overhead of time domain is absent.

More specifically, in the time domain, the throughput is consistently high regardless of the number of resource blocks (RB) that are allocated for uplink/downlink data. The RB is the smallest unit of resources that can be allocated for uplink/downlink data, where each block carries 12 consecutive tones. A base station configures RB allocation for uplink/downlink. For a full RB allocation configuration, the overhead of a sample is 33%. For a partial RB allocation, overhead can be more than 273 times the allocated RB. To accommodate a high peak throughput, existing solutions in the time domain employ multiple data lanes for the digital interface, which significantly increase power consumption and require a larger board area for the digital interface. Hence, the disclosed digital interface can be physically more compact with fewer lanes compared to existing digital interfaces because the prior need for higher throughput is reduced.

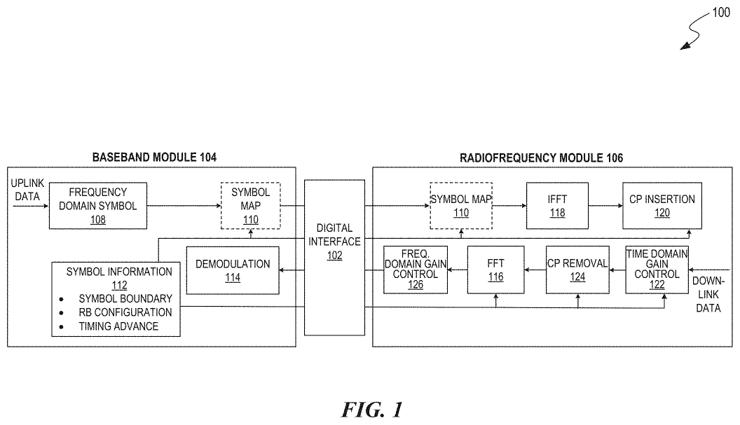

The disclosed digital interface overcomes the aforementioned drawbacks. For example, FIG. 1 is a block diagram that illustrates an architecture 100 for an electronic circuit including a digital interface 102. A BB module 104 is connected to an RF module 106 through the digital interface 102. As shown, components of the BB module 104 include a frequency domain symbol module 108, an optional symbol map 110, a symbol information module 112, and a demodulation module 114. The symbol information module 112 is an example of a control information module that maintains control information such as boundary information, RB configuration information, and timing advance information. In one example, the control information is symbol information including symbol boundary, RB configuration, and timing advance information.

The symbol information that is maintained at the BB module 104 is transferred to RF module 104 at different points in time (e.g., periodically, as needed). For example, the symbol information can be transferred in response to changes of the base station, such that the modules of the RF module 106 are updated based on the changes. The symbol boundary information includes control mechanisms established for the RF module 106 to identify a symbol boundary and a beginning of symbol in the time domain. The RB configuration information is a function of the symbol map 110, which needs to know which RB are allocated for uplink/downlink, to map symbols to the allocated RB. The timing advance refers to, for example, a signal of the base station to indicate a point in time when a mobile device (e.g., user equipment) should stop transmitting data.

The components of the RF module 106 include an optional symbol map 110, an FFT engine 116, an IFFT engine 118, a cyclic prefix (CP) insertion module 120, a time domain gain control module 122, a CP removal module 124, and a frequency domain gain control module 126. The FFT engine 116 and IFFT engine 118 are disposed on the RF module 106 instead of being disposed on a BB module as in conventional digital interfaces. The FFT engine 118 is configured to convert time domain data (e.g., samples) to frequency domain data. The IFFT engine 118 is configured to convert frequency domain samples to time domain samples. Therefore, the conversion between time domain and frequency domain samples occurs at the RF module 106.

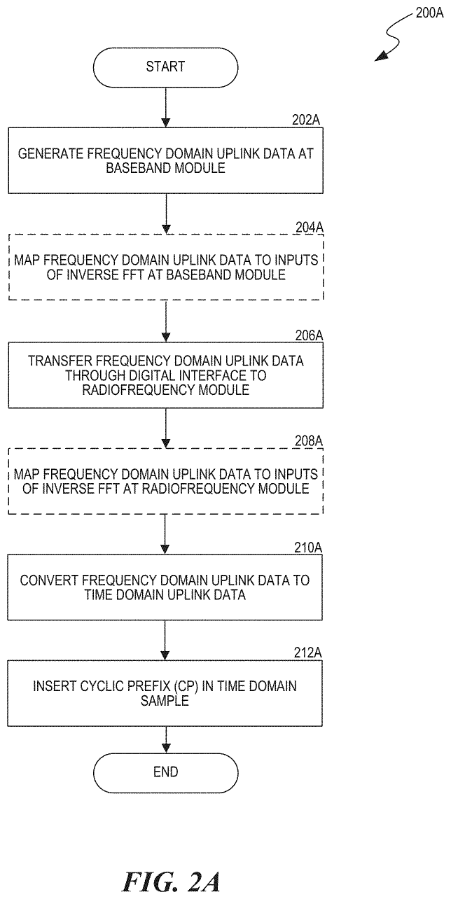

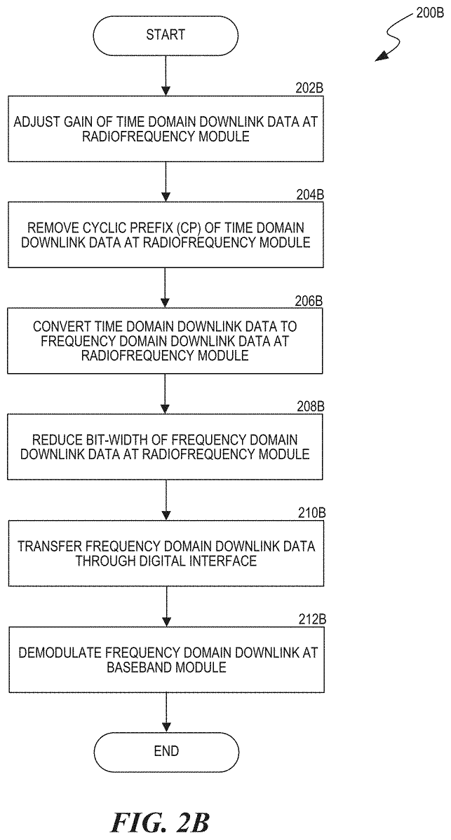

The architecture 100 provides operational improvements over conventional technology. For example, FIG. 2A is a flowchart that illustrates a process 200A for processing uplink data. At 202, the frequency domain symbol module 108 at the BB module 104 generates the frequency domain uplink data (e.g., symbol data). The frequency domain symbol module 108 can generate symbols in accordance with, for example, a modulation technique such as Quadrature Phase Shift Keying (QPSK). As shown in FIG. 1, the symbol map 110 or another map module function is optionally at the BB module 104 or the RF module 106.

At 204A, the symbol map 110 is at the BB module 104 and maps the frequency domain uplink data to inputs of the IFFT engine 118. For example, the symbol map 110 can map symbols to input tones of the IFFT engine 118 (as a symbol index), which further reduces throughput through the digital interface compared to passing the unmapped symbol data. The mapping is determined based in part on symbol information obtained from the symbol information module 112. Examples of the symbol information include symbol boundary information and RB configuration information. The RB configuration information indicates which RB are allocated for uplink data. As such, the symbol map 110 can map symbols to the appropriate RB that are allocated for uplink.

At 206A, the frequency domain uplink data is transferred through the digital interface 102 to the RF module 104. At 208A, if the symbol map 110 is at the RF module 106, the frequency domain uplink data that is transferred through the digital interface 102 is then mapped to input tones of the IFFT engine 118. Either way, frequency domain uplink data is passed through the digital interface 102 instead of time domain uplink data, which significantly reduces the throughput over the digital interface 102. Moreover, in the event that only some tones for certain symbols are used for uplink data, throughput is reduced because the total bits per symbol scale in the frequency domain, unlike the fixed amount of total bits per symbol in the time domain.

At 210A, the IFFT engine 118 converts the frequency domain uplink data to time domain uplink data. At 212A, the CP insertion module 120 is configured to then insert a CP in a time domain uplink data. The position in the time domain uplink data for inserting the CP is determined based in part on the symbol boundary information and a timing advance obtained from the symbol information module 112 at the BB module 104.

FIG. 2B is a flowchart that illustrates a process 200B for processing downlink data. At 202B, the time domain gain control module 122 of the RF module 106 adjusts a gain of time domain downlink data. The position for the adjustment is determined based in part on symbol boundary information obtained from the symbol information module 112. At 204B, the CP removal module 124 removes CP of the time domain downlink data, which is also determine in part based on symbol boundary information obtained from the symbol information module 112. At 206B, the FFT engine 116 converts the time domain downlink data into frequency domain downlink data. At 208B, the frequency domain gain control module 126 reduces the bit-width of the frequency domain downlink data to further reduce throughput over the digital interface 102. At 210B, the frequency domain downlink data is transferred through the digital interface 102 to the BB module 104. In one example, selected RB in the frequency domain are transmitted through the digital interface 102 to the BB module 104. At 212B, the demodulation module 114 at the BB module 104 demodulates the frequency domain downlink data.

TABLE 1 includes examples that demonstrate improvements measured as a throughput ratio of time and frequency. In the examples, data is transferred at 100 MHz CP-s-OFDM. Two examples are considered: max 273 RB and min 1 RB. Every sample (time or frequency domain) is assumed to have total 24 bits (12 bit I+12 bit Q). For frequency domain sample, RB configuration info is assumed to use 32 bits.

TABLE 1 illustrates the consequences that result from keeping time domain total bits per symbol constant, regardless of the number of RB. As shown, there is proportionally more overhead as the number of RB decrease. On the other hand, the frequency domain total bits per symbol scales with the number of RB because the overhead required to maintain a fixed number of total bits is absent. As such, as illustrated in the table, at least a 33% throughput saving is achieved for full RB (273) allocation. More throughput saving is achieved for a smaller number of RB in the frequency domain because the overhead in the time domain does not scale down.

TABLE 1

| | | | | | | | | | | Throughput |
|---|---|---|---|---|---|---|---|---|---|---|
| | | | | | | | | | | ratio |
| | | | | | | | | | | (time/freq.) |
| | | | | | | | | | | Total bits |
| | | | | | Time domain sample | | | | | per symbol |
| | | | | | | | # of | | | in time |
| | | | | | | | samples | | | domain/ |
| | Freq domain sample | | | | | | (FFT | | | Total bits |
| | | # bits | # bits | Total | | | size + | # bits | Total | per symbol |
| | # | per | for RB | bits per | FFT | CP | CP | per | bits per | in frequency |
| | samples | sample | config. | symbol | size | length | length) | sample | symbol | domain |
| 100 MHz | 12 | 24 | 32 | 320 | 4096 | 288 | 4384 | 24 | 105216 | 328.8 |
| 1RB | | | | | | | | | | |
| 100 MHz | 3276 | 24 | 32 | 78656 | 4096 | 288 | 4384 | 24 | 105216 | 1.33 |
| 273RB | | | | | | | | | | |

Therefore, the proposed solution includes a throughput savings by avoiding the burden of constantly supporting high throughput.

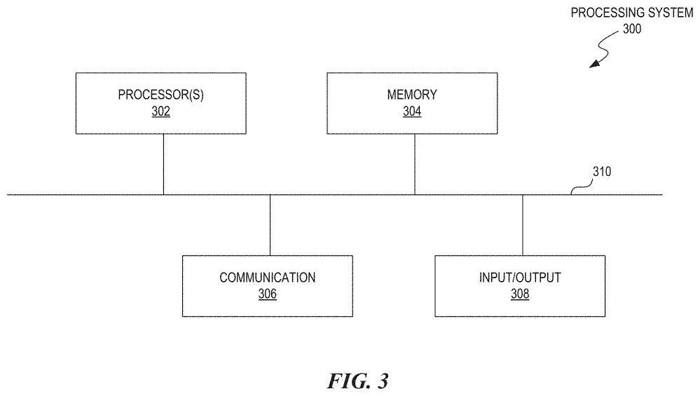

FIG. 3 is a block diagram illustrating an example of a processing system 300 in which at least some operations described herein can be implemented. The processing system 300 represents a system that can run any of the methods/algorithms described herein. For example, any device or component (e.g., module) of the architecture 100 can include or be part of a processing system 300. The processing system 300 can include one or more processing devices, which can be coupled to each other via a network or multiple networks. A network can be referred to as a communication network or telecommunications network.

In the illustrated embodiment, the processing system 300 includes one or more processors 302, memory 304, a communication device 306, and one or more input/output (I/O) devices 308, all coupled to each other through an interconnect 310. The interconnect 310 can be or include one or more conductive traces, buses, point-to-point connections, controllers, adapters and/or other conventional connection devices. Each of the processor(s) 302 can be or include, for example, one or more general-purpose programmable microprocessors or microprocessor cores, microcontrollers, application specific integrated circuits (ASICs), programmable gate arrays, or the like, or a combination of such devices.

The processor(s) 302 control the overall operation of the processing system 300. Memory 304 can be or include one or more physical storage facilities, which can be in the form of random-access memory (RAM), read-only memory (ROM) (which can be erasable and programmable), flash memory, miniature hard disk drive, or other suitable type of storage device, or a combination of such devices. Memory 304 can store data and instructions that configure the processor(s) 302 to execute operations in accordance with the techniques described above. The communication device 306 can be or include, for example, an Ethernet adapter, cable modem, Wi-Fi adapter, cellular transceiver, Bluetooth transceiver, or the like, or a combination thereof. Depending on the specific nature and purpose of the processing system 300, the I/O devices 308 can include devices such as a display (which can be a touch screen display), audio speaker, keyboard, mouse or other pointing device, microphone, camera, etc.

While processes or blocks are presented in a given order, alternative embodiments can perform routines having steps or employ systems having blocks, in a different order, and some processes or blocks can be deleted, moved, added, subdivided, combined and/or modified to provide alternative or sub-combinations, or can be replicated (e.g., performed multiple times). Each of these processes or blocks can be implemented in a variety of different ways. In addition, while processes or blocks are at times shown as being performed in series, these processes or blocks may instead be performed in parallel, or can be performed at different times. When a process or step is “based on” a value or a computation, the process or step should be interpreted as based at least on that value or that computation.

Software or firmware to implement the techniques introduced here can be stored on a machine-readable storage medium and can be executed by one or more general-purpose or special-purpose programmable microprocessors. A “machine-readable medium”, as the term is used herein, includes any mechanism that can store information in a form accessible by a machine (a machine can be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random-access memory (RAM), magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 300 can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory can be volatile or non-volatile memory. In some embodiments, the volatile memory can be considered “non-transitory” in the sense that it is not a transitory signal. Memory space and storage described in the figures can be implemented with the tangible storage memory as well, including volatile or non-volatile memory.

Each of the functional components can operate individually and independently of other functional components. Some or all of the functional components can be executed on the same host device or on separate devices. The separate devices can be coupled through one or more communication channels (e.g., wireless or wired channel) to coordinate their operations. Some or all of the functional components can be combined as one component. A single functional component can be divided into sub-components, each sub-component performing separate method steps or a method step of the single component.

In some embodiments, at least some of the functional components share access to a memory space. For example, one functional component can access data accessed by or transformed by another functional component. The functional components can be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems and devices described above can include additional, fewer, or different functional components for various applications.

Aspects of the disclosed embodiments can be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a set of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system. For example, some network elements are described herein as performing certain functions. Those functions could be performed by other elements in the same or differing networks, which could reduce the number of network elements. Alternatively or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. One will also appreciate that the actual implementation of a database can take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments. Aspects of the disclosure can be modified, if necessary, to employ the systems, functions, and concepts of the various references described above to provide yet further embodiments of the disclosure.

These and other changes can be made to the invention in light of the above Detailed Description. While the above description describes certain embodiments of the disclosure, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the disclosed techniques should not be taken to imply that the terminology is being redefined herein to be restricted to any specific characteristics, features, or aspects of the disclosed techniques with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the disclosed techniques are presented below in certain claim forms, the inventors contemplate the various aspects of the techniques in any number of claim forms. For example, while only one aspect of the invention is recited as embodied in a computer-readable medium, other aspects can likewise be embodied in a computer-readable medium. Accordingly, the inventors reserve the right to add additional claims after filing the application to pursue such additional claim forms for other aspects of the disclosed techniques.

I/We claim:

1. An electronic circuit comprising:
a baseband (BB) integrated circuit (IC) semiconductor device configured to generate frequency domain uplink data;
a radiofrequency (RF) IC semiconductor device including:
a fast Fourier transfer (FFT) module disposed on the RF IC semiconductor device and configured to convert time domain downlink data to frequency domain downlink data; and
an inverse fast Fourier transfer (IFFT) module disposed on the RF IC semiconductor device and configured to convert the frequency domain uplink data to time domain uplink data; and
a digital interface configured to transfer the frequency domain uplink data from the BB IC semiconductor device to the RF IC semiconductor device and transfer the frequency domain downlink data from the RF IC semiconductor device to the BB IC semiconductor device.

2. The electronic circuit of claim 1, wherein the BB IC semiconductor device comprises:
a map module configured to map the frequency domain uplink data to inputs of the IFFT module disposed on the RF IC semiconductor device.

3. The electronic circuit of claim 1, wherein the RF IC semiconductor device comprises:
a map module configured to map the frequency domain uplink data to inputs of the IFFT module disposed on the RF IC semiconductor device.

4. The electronic circuit of claim 1, wherein the BB IC semiconductor device comprises:
a control information module configured to maintain control information and transfer the control information from the BB IC semiconductor device through the digital interface to the RF IC semiconductor device,
wherein the control information includes boundary information, resource block configuration information, and timing advance information.

5. The electronic circuit of claim 1, wherein the BB IC semiconductor device comprises:
a demodulation module configured to demodulate the frequency domain downlink data.

6. The electronic circuit of claim 1, wherein the RF IC semiconductor device comprises:
a cyclic prefix (CP) insertion module configured to insert a CP in the time domain uplink data based on control information transferred through the digital interface from the BB IC semiconductor device.

7. The electronic circuit of claim 1, wherein the RF IC semiconductor device comprises:
a time domain gain control module configured to adjust a gain of the time domain downlink data.

8. The electronic circuit of claim 1, wherein the RF IC semiconductor device comprises:
a cyclic prefix (CP) removal module configured to remove a CP of the time domain uplink data based on control information transferred from the BB IC semiconductor device through the digital interface to the RF IC semiconductor device.

9. The electronic circuit of claim 1, wherein the RF IC semiconductor device comprises:
a frequency domain gain control module configured to adjust a gain of the frequency domain downlink data based on control information transferred from the BB IC semiconductor device through the digital interface to the RF IC semiconductor device.

10. A method for processing uplink data, the method comprising:
generating, at a baseband (BB) integrated circuit (IC) semiconductor device, frequency domain uplink data;
transferring, through a digital interface, the frequency domain uplink data to a radiofrequency (RF) IC semiconductor device; and
processing, at the RF IC semiconductor device, the transferred frequency domain uplink data with an inverse fast Fourier transfer (IFFT) module to convert the transferred frequency domain uplink data to time domain uplink data, the IFFT module being disposed on the RF IC semiconductor device.

11. The method of claim 10 further comprising, prior to transferring the frequency domain uplink data to the RF IC semiconductor device:
mapping, at the BB IC semiconductor device, the frequency domain uplink data to inputs of the IFFT module to produce a symbol index,
wherein the transferred frequency domain uplink data corresponds to the symbol index.

12. The method of claim 10 further comprising, prior to converting the transferred frequency domain uplink data to the time domain uplink data:
mapping, at the RF IC semiconductor device, the frequency domain uplink data to inputs of the IFFT module disposed on the RF IC semiconductor device.

13. The method of claim 10 further comprising:
inserting, at the RF IC semiconductor device, a cyclic prefix (CP) in the time domain uplink data based on control information transferred from the BB IC semiconductor device through the digital interface to the RF IC semiconductor device,
wherein the control information includes an indication of a position in the time domain uplink data and a timing advance.

14. The method of claim 10, wherein the frequency domain uplink data includes symbols, the method further comprises:
mapping, at the RF IC semiconductor device, the symbols to input tone of the IFFT module in accordance with symbol boundary information and resource block configuration information transferred from the BB IC semiconductor device through the digital interface to the RF IC semiconductor device.

15. The method of claim 10, wherein the frequency domain uplink data includes symbols that are mapped to input tones of the IFFT module disposed on the RF IC semiconductor device.

16. A method for processing downlink data, the method comprising:
obtaining, at a radiofrequency (RF) integrated circuit (IC) semiconductor device, time domain downlink data;
processing, at the RF IC semiconductor device, the time domain downlink data with a fast Fourier transfer (FFT) module to convert the time domain downlink data to frequency domain downlink data, the FFT module being disposed on the RF IC semiconductor device;
transferring, through a digital interface, the frequency domain downlink data from the RF IC semiconductor device through the digital interface to a baseband (BB) IC semiconductor device; and
demodulating, at the BB IC semiconductor device, the transferred frequency domain downlink data.

17. The method of claim 16 further comprising, prior to transferring the frequency domain downlink data through the digital interface:
reducing a bit-width of the frequency domain downlink data.

18. The method of claim 16 further comprising, prior to processing the time domain downlink data with the FFT module disposed on the RF IC semiconductor device:
removing, at the RF IC semiconductor device, a cyclic prefix (CP) in the time domain downlink data based on control information transferred from the BB IC semiconductor device to the RF IC semiconductor device,
wherein the control information includes an indication of a position in the time domain downlink data.

19. The method of claim 16 further comprising, prior to transferring the frequency domain downlink data over the digital interface:
adjusting, at the RF IC semiconductor device, a gain of the time domain downlink data.

20. The method of claim 16, wherein time domain data is processed at the RF IC semiconductor device in accordance with symbol information obtained from the BB IC semiconductor device, and wherein the symbol information includes symbol boundary information, resource block configuration information, or timing information.
